(19) United States
(12) Patent Application Publication
(10) Pub. No.: US 2025/0029422 A1
(43) Pub. Date: Jan. 23, 2025

(54) DETECTION SYSTEM, DETECTION METHOD, AND NON-TRANSITORY STORAGE MEDIUM

(71) Applicant: TOYOTA JIDOSHA KABUSHIKI KAISHA, Toyota-shi (JP)

(72) Inventors: Takuma Sugino, Miyoshi-shi (JP); Masahiro Kagi, Toyota-shi (JP)

(73) Assignee: TOYOTA JIDOSHA KABUSHIKI KAISHA, Toyota-shi (JP)

(21) Appl. No.: 18/755,880

(22) Filed: Jun. 27, 2024

(30) Foreign Application Priority Data
Jul. 21, 2023 (JP) 2023-119310

(51) Int. Cl. G06V 40/20

(52) U.S. Cl. CPC G06V 40/20

(57) ABSTRACT

A detection system according to the present disclosure includes: a foot detection unit that detects a position of a foot of a detection target person; an upper body detection unit that detects a position of at least part of an upper body of the detection target person; and an estimation unit that estimates the state of the detection target person based on the moving distance of the foot calculated by using the detected position of the foot and based on the moving distance of the at least part of the upper body calculated by using the detected position of the at least part of the upper body.

### CROSS-REFERENCE TO RELATED APPLICATION

This application claims priority to Japanese Patent Application No. 2023-119310 filed on Jul. 21, 2023 incorporated herein by reference in its entirety.

### BACKGROUND

### 1. Technical Field

The present disclosure relates to a control system, a control method, and a non-transitory storage medium.

### 2. Description of Related Art

Japanese Patent No. 6892393 discloses a foot contact position tracking device that detects the position at which a human foot contacts the ground by receiving and processing an image captured by a camera.

### SUMMARY

Such a technique of detecting the position of a human part using image processing is occasionally used in the field of artificial intelligence (AI), such as machine learning and deep learning, to generate teaching data, for example.

The inventors have found the following issue.

The state of a detection target person is varied when a foot of the detection target person is hidden behind an obstacle, the posture of the detection target person is varied, etc. With such a foot contact position tracking device, whether the result of detecting the position of a human foot is correct or wrong is occasionally varied according to the state of the detection target person. Therefore, the precision of detecting the position of a human foot can be enhanced if it is possible to estimate the state of the detection target person. Thus, there is a demand to make it possible to estimate the state of the detection target person.

The present disclosure has been made in view of the issue discussed above, and provides a detection system, a detection method, and a program that make it possible to estimate the state of a detection target person.

An aspect of the present disclosure provides a detection system including:
a foot detection unit configured to detect a position of a foot of a detection target person;
an upper body detection unit configured to detect a position of at least part of an upper body of the detection target person; and
an estimation unit configured to estimate a state of the detection target person based on a moving distance of the foot calculated by using the detected position of the foot and based on a moving distance of the at least part of the upper body calculated by using the detected position of the at least part of the upper body.

In the detection system discussed above, the estimation unit may be configured to estimate that at least part of a lower body of the detection target person is hidden behind an obstacle in a case where only the moving distance of the foot is more than a predetermined value and only the foot is moved in an up-down direction.

In the detection system discussed above, the estimation unit may be configured to estimate that the detection target person is going up or down stairs, or that the detection target person is jumping, in a case where the moving distance of the foot and the moving distance of the at least part of the upper body are more than a predetermined value and the foot and the at least part of the upper body are moved in an up-down direction.

In the detection system discussed above, the estimation unit may be configured to estimate that a posture of the detection target person is varied, or that the at least part of the upper body of the detection target person is hidden behind an obstacle, in a case where only the moving distance of the at least part of the upper body is more than a predetermined value.

In the detection system discussed above, a correction unit may be further provided, and
the correction unit may be configured to correct the detected position of the foot to a position of the foot based on a skeleton of the detection target person in a case where the estimation unit estimates that at least part of a lower body of the detection target person is hidden behind an obstacle.

An aspect of the present disclosure provides a detection method performed by a detection system, including:
detecting a position of a foot of a detection target person;
detecting a position of at least part of an upper body of the detection target person; and
estimating a state of the detection target person based on a moving distance of the foot calculated by using the detected position of the foot and based on a moving distance of the at least part of the upper body calculated by using the detected position of the at least part of the upper body.

An aspect of the present disclosure provides a non-transitory storage medium storing instructions that are executable by one or more processors operating in a detection system and that cause the one or more processors to perform functions including: detecting a position of a foot of a detection target person;
detecting a position of at least part of an upper body of the detection target person; and
estimating a state of the detection target person based on a moving distance of the foot calculated by using the detected position of the foot and based on a moving distance of the at least part of the upper body calculated by using the detected position of the at least part of the upper body.

According to the present disclosure, it is possible to estimate the state of a detection target person.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating an example of the configuration of a detection system according to an embodiment;

FIG. 2 is a flowchart illustrating an example of a detection method according to the embodiment;

FIG. 3 illustrates an image for the example of the detection method according to the embodiment;

FIG. 4 illustrates an image for the example of the detection method according to the embodiment;

FIG. 5 illustrates an image for the example of the detection method according to the embodiment;

FIG. 6 illustrates an image for the example of the detection method according to the embodiment;

FIG. 7 illustrates an image for the example of the detection method according to the embodiment;

FIG. 8 illustrates an image for the example of the detection method according to the embodiment;

FIG. 9 illustrates an example of the configuration of hardware components included in the detection system; and

FIG. 10 is a flowchart illustrating another example of the detection method according to the embodiment.

### DETAILED DESCRIPTION OF EMBODIMENTS

A specific embodiment of the present disclosure will be described in detail below with reference to the drawings. The present disclosure is not limited to the following embodiment. In order to clarify description, the following description and the drawings are simplified as appropriate.

### EMBODIMENT

### Configuration

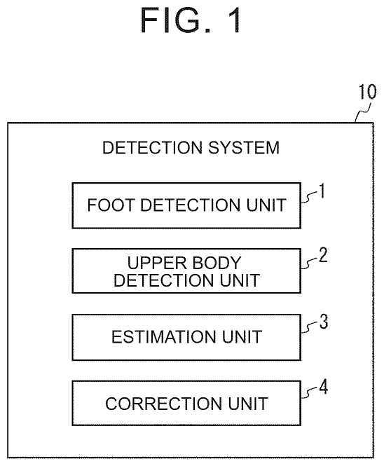

An example of the configuration of a detection system according to an embodiment will be described with reference to FIG. 1.

As illustrated in FIG. 1, a detection system 10 includes a foot detection unit 1, an upper body detection unit 2, and an estimation unit 3. Preferably, the detection system 10 further includes a correction unit 4. The various units of the detection system 10 are preferably implemented through cooperation of one or more programs installed in a computer device that constitutes the detection system 10 and hardware such as a processor and a memory of the computer device.

The foot detection unit 1 detects the position of feet of a detection target person from an image. The foot detection unit 1 may detect the position of legs, heels, toes, etc. of the detection target person, for example. The upper body detection unit 2 detects the position of at least part of an upper body of the detection target person from the image. Examples of the at least part of the upper body of the detection target person include a head, a trunk, and the entire upper body.

Specifically, the foot detection unit 1 and the upper body detection unit 2 acquire an image in which the detection target person is a subject. The foot detection unit 1 and the upper body detection unit 2 specify the detection target person in the acquired image, and generate information that indicates the area of the detection target person. Examples of this information include a bounding box. The foot detection unit 1 detects the midpoint of the lower side of a rectangle indicated by the bounding box as the position of the feet of the detection target person, for example. The upper body detection unit 2 detects the midpoint of the upper side of the rectangle indicated by the bounding box as the position of the head of the detection target person, for example.

The estimation unit 3 estimates the state of the detection target person based on the moving distance of the feet and the moving distance of the upper body. Specifically, the estimation unit 3 calculates the moving distance of the feet using the position of the feet detected by the foot detection unit 1. The estimation unit 3 also calculates the moving distance of the upper body using the position of at least part of the upper body detected by the upper body detection unit 2.

The correction unit 4 corrects the position of the feet detected by the foot detection unit 1 to the position of the feet based on a skeleton of the detection target person. Specifically, the correction unit 4 specifies the position of joints of the detection target person. The correction unit 4 also estimates the position of the feet of the detection target person based on the position of the joints. The correction unit 4 further corrects the position of the feet detected by the foot detection unit 1 to the estimated position of the feet. More specifically, the correction unit 4 specifies the position of joints from the head to ankles of the detection target person, the position of joints of thighs and lower thighs of the detection target person, etc. The correction unit 4 also estimates the position of the toes of the detection target person based on the specified position of the joints. The correction unit 4 further corrects the position of the feet detected by the foot detection unit 1 to the estimated position of the toes.

The detection system 10 may include a generation unit that captures an image that may include the detection target person as a subject and that generates data that indicate the captured image. Examples of the generation unit include a camera device. The detection system 10 may also include a storage unit that stores various data including information in which the data that indicate the captured image and the time point when the image was captured are correlated with each other. The time point when the image was captured may be calculated from the frame rate, for example. The data that indicate the captured image are preferably correlated with the information that indicates the area of the detection target person described above, the position of feet detected by the foot detection unit 1, the position of at least part of the upper body detected by the upper body detection unit 2, the moving distance of feet calculated by the estimation unit 3, the moving distance of the upper body calculated by the estimation unit 3, etc.

### Detection Method

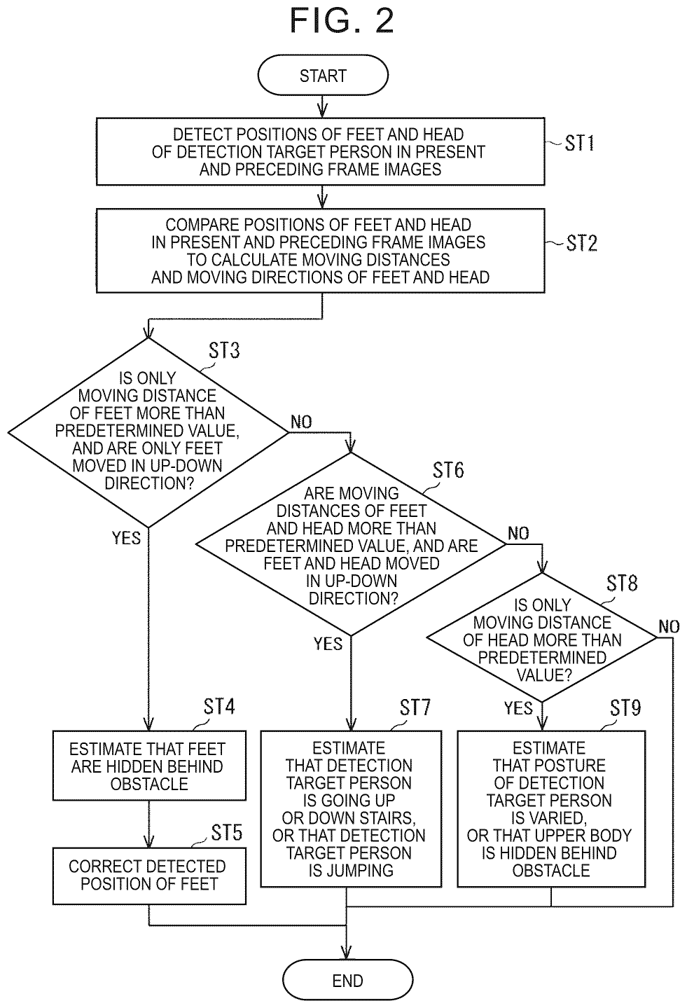

Next, an example of a detection method performed by the detection system 10 according to the embodiment will be described with reference to FIG. 2. FIG. 2 is a flowchart illustrating an example of a detection method according to the embodiment.

The positions of the feet and the head of the detection target person in a present frame image and a preceding frame image are detected (ST1).

Subsequently, the positions of the feet and the head of the detection target person in the present frame image and the preceding frame image are compared to calculate the moving distance and the moving direction of the feet and the head (ST2).

Subsequently, it is determined whether only the moving distance of the feet is more than a predetermined value and only the feet are moved in the up-down direction (ST3). The predetermined value may be a distance walked by the detection target person during a period t that has elapsed since the time point when the preceding frame image was captured until the time point when the present frame image was captured, for example. The period t may be calculated from the frame rate of the camera device described above. The distance walked by the detection target person during the period t may be calculated by multiplying the walking speed of the detection target person by the period t. The walking speed of the detection target person may be acquired from known data in advance.

When only the moving distance of the feet is more than the predetermined value and only the feet are moved in the up-down direction (ST3: YES), it is estimated that at least part of the lower body of the detection target person is hidden behind an obstacle (ST4). Thus, the position of the feet in the present frame image detected in ST1 is actually the same position as an upper portion of the obstacle, and is different from the actual position of the feet. Hence, the position of the feet in the present frame image detected in ST1 is wrong. Further, the position of the feet in the present frame image detected in ST1 is corrected to the position of the feet based on the skeleton of the detection target person (ST5). This correction enhances the precision of detecting the position of the feet in the present frame image. After ST5 is performed, the present detection method is ended.

If not (ST3: NO), it is determined whether the moving distance of the feet and the moving distance of the head are more than the predetermined value and the feet and the head are moved in the up-down direction (ST6).

When the moving distance of the feet and the moving distance of the head are more than the predetermined value and the feet and the head are moved in the up-down direction (ST6: YES), it is estimated that the detection target person is going up or down the stairs, or that the detection target person is jumping (ST7).

If not (ST6: NO), it is determined whether only the moving distance of the head is more than the predetermined value (ST8).

When only the moving distance of the head is more than the predetermined value (ST8: YES), it is estimated that the posture of the detection target person is varied, or that at least part of the upper body of the detection target person is hidden behind an obstacle (ST9). The present detection method is ended.

If not (ST8: NO), the present detection method is ended. The present detection method is ended also after ST7 and ST9. When the posture of the detection target person is varied, or when at least part of the upper body of the detection target person is hidden behind an obstacle, it is estimated that the position of the feet is correct, and thus it is not necessary to correct the detected position of the feet.

The state of the detection target person can be estimated in the manner described above. The necessity to correct the detected position of the feet is determined according to the estimation result, and the detected position of the feet is corrected as necessary. As a result, it is possible to accurately detect the position of the feet of the detection target person. In addition, a path along which the feet of the detection target person have been moved can be calculated by continuously detecting the position of the feet of the detection target person and connecting points that indicate the detected positions of the feet.

### First Specific Example of Detection Method

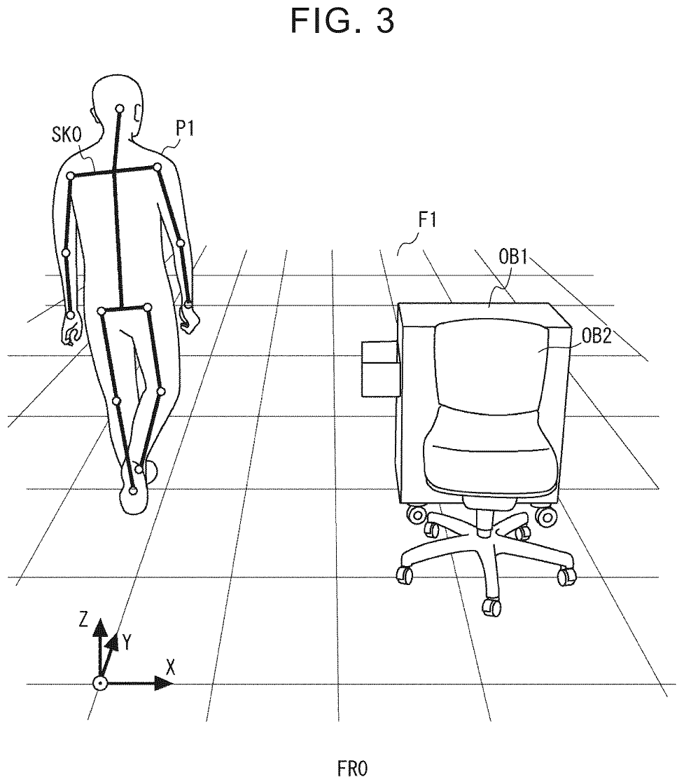

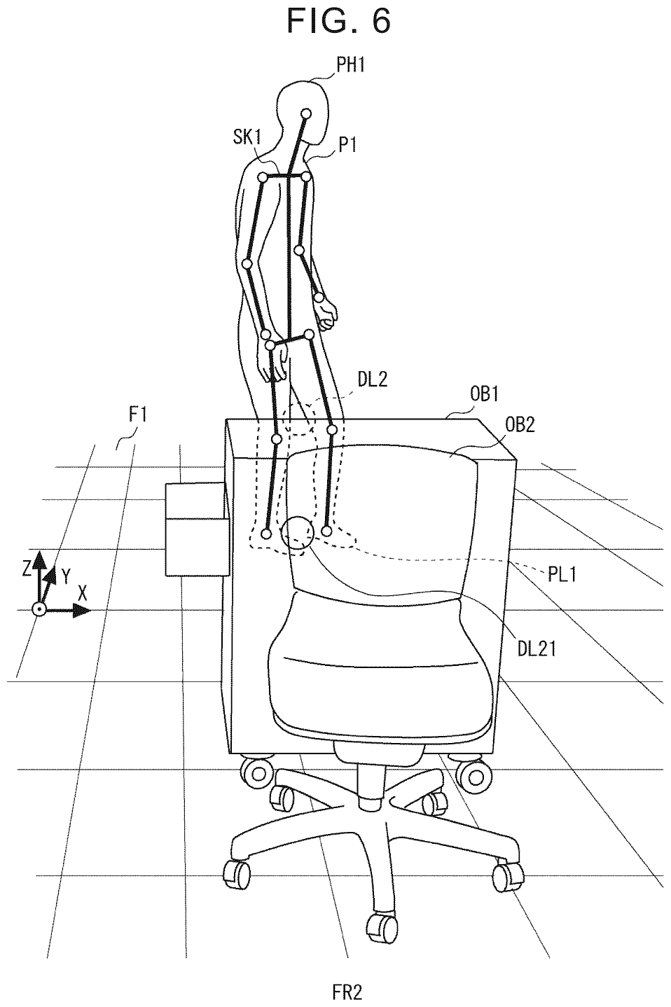

Next, a first specific example of the detection method performed by the detection system 10 will be described with reference to FIGS. 3 to 6.

As a matter of course, a right-handed XYZ coordinate system illustrated in FIG. 3 and other drawings is provided for convenience in order to illustrate the positional relationship among the constituent elements. Normally, the positive direction along the Z axis is a vertically upward direction, and the XY plane is a horizontal plane, which is common among the drawings.

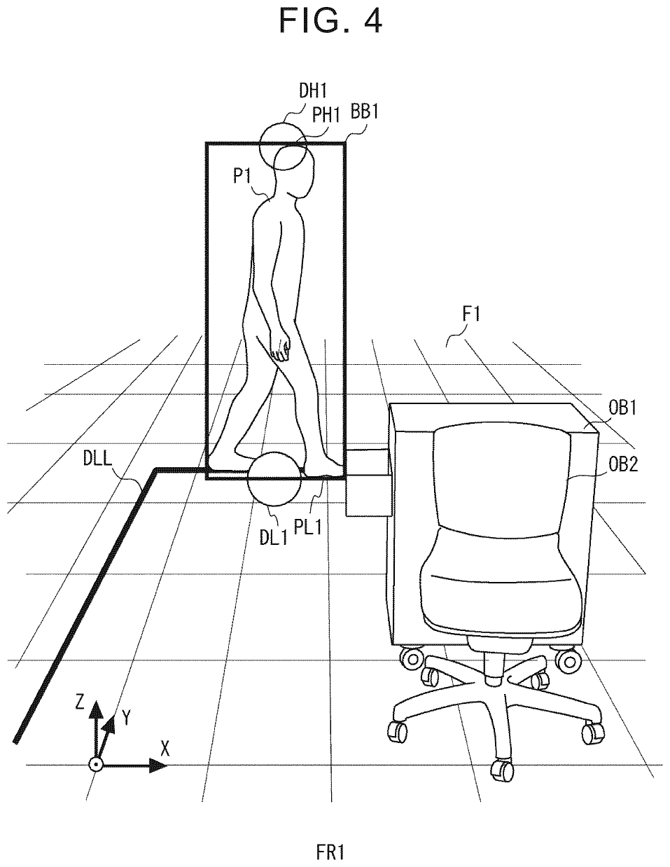

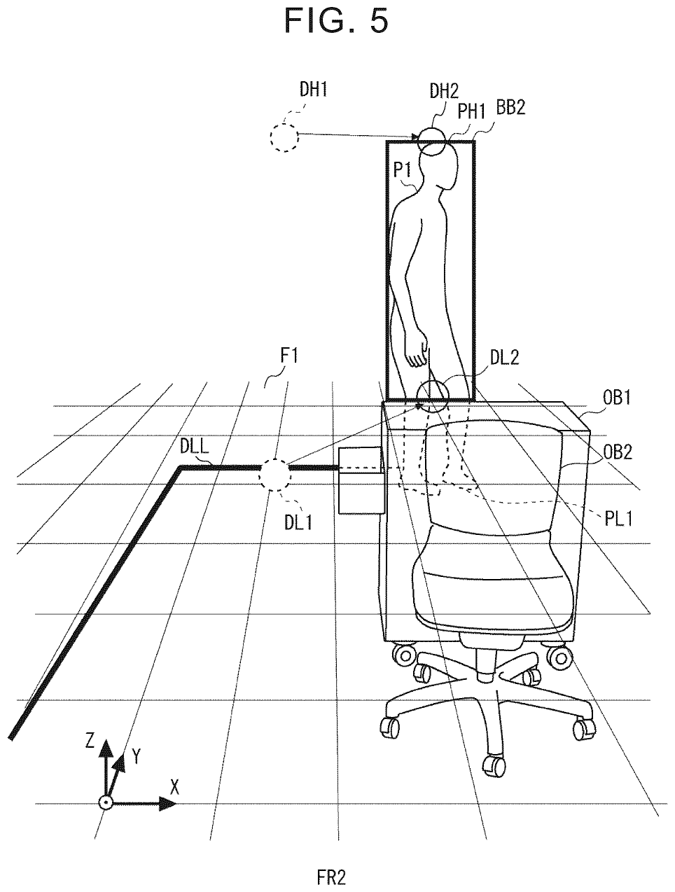

In the present specific example, as illustrated in FIG. 3, a detection target person P1 walking on a floor surface F1 on which obstacles OB1, OB2 are placed is captured every moment, and the detection method performed by the detection system 10 is applied to a plurality of images captured in this manner. The obstacle OB1 is a drawer unit with wheels, and the obstacle OB2 is a chair. The floor surface F1 extends along the XY plane, that is, a horizontal plane. The detection target person P1 moves along a path DLL indicated in FIGS. 4 and 5 on the floor surface F1. That is, the detection target person P1 moves in the positive Y-axis direction and thereafter moves in the positive X-axis direction on the floor surface F1. As illustrated in FIG. 3, a skeleton model SKI is prepared by being estimated from the skeleton of the detection target person P1. The skeleton model SKI is superimposed on a portion that indicates the detection target person P1 in the image. FIG. 5 illustrates a present frame image FR2. FIG. 4 illustrates a preceding frame image FR1 captured immediately before the present frame image FR2 illustrated in FIG. 5.

In ST1, a bounding box BB1 as a region that indicates the detection target person P1 is generated in the preceding frame image FR1 illustrated in FIG. 4. The foot detection unit 1 detects the midpoint of the lower side of a rectangle indicated by the bounding box BB1 as a position DL1 of feet PL1 of the detection target person P1. The upper body detection unit 2 detects the midpoint of the upper side of the rectangle indicated by the bounding box BB1 as a position DH1 of a head PH1 of the detection target person P1. The detected position DL1 is substantially the same as the actual position of the feet PL1, and the detected position DH1 is substantially the same as the actual position of the head PH1. Hence, the position of the feet PL1 and the position of the head PH1 of the detection target person P1 can be detected with high precision.

Similarly, a bounding box BB2 as a region that indicates the detection target person P1 is generated in the present frame image FR2 illustrated in FIG. 5. The foot detection unit 1 detects the midpoint of the lower side of a rectangle indicated by the bounding box BB2 as a position DL2 of the feet PL1 of the detection target person P1. The upper body detection unit 2 detects the midpoint of the upper side of the rectangle indicated by the bounding box BB2 as a position DH2 of the head PH1 of the detection target person P1. The detected position DH2 is substantially the same as the actual position of the head PH1. On the other hand, the detected position DL2 is away from the actual position of the feet PL1. Hence, while the position of the head PH1 of the detection target person P1 is detected with high precision, the position of the feet PL1 is not detected with high precision.

In ST2, the position DL1 and the position DL2 are compared to calculate the moving distance and the moving direction of the feet PL1. The distance between the position DL1 and the position DL2 is the moving distance of the feet PL1. The moving direction of the feet PL1 is an oblique direction that extends in the positive X-axis direction and the positive Z-axis direction, and includes an up-down direction and a horizontal direction.

Similarly, the position DH1 and the position DH2 are compared to calculate the moving distance and the moving direction of the head PH1. The distance between the position DH1 and the position DH2 is the moving distance of the head PH1. The moving direction of the head PH1 is a horizontal direction that extends substantially in the positive X-axis direction.

In ST3, it is determined whether only the moving distance of the feet PL1 is more than a predetermined value and only the feet PL1 are moved in the up-down direction. While the moving distance of the feet PL1 is the distance between the position DL1 and the position DL2 and is more than the predetermined value, the moving distance of the head PH1 is the distance between the position DH1 and the position DH2 and is not more than the predetermined value. Hence, only the moving distance of the feet PL1 is more than the predetermined value. Since the feet PL1 are moved also in the up-down direction while the head PH1 is moved in the horizontal direction as described above, only the feet PL1 are moved in the up-down direction. Hence, it is determined that only the moving distance of the feet PL1 is more than the predetermined value and only the feet PL1 are moved in the up-down direction (ST3: YES).

In ST4, it is estimated that the feet PL1 are hidden behind an obstacle. The actual feet PL1 are hidden behind the obstacles OB1, OB2.

In ST5, the position DL2 of the feet PL1 in the present frame image FR2 detected in ST1 is corrected to a position DL21 of the feet PL1 based on the skeleton of the detection target person P1. Specifically, the skeleton model SKI is estimated from the skeleton from the head to knees of the detection target person P1 included in the bounding box BB1. The skeleton model SKI is superimposed on a portion that indicates the detection target person P1 in the present frame image FR2. The midpoint of two feet of the skeleton model SKI is corrected to the position DL21 of the feet PL1 of the detection target person P1. Consequently, the position DL2 is corrected to the position DL21. The position DL21 is substantially the same as the actual position of the feet PL1. Hence, the position of the feet PL1 of the detection target person P1 can be corrected and detected with high precision.

### Second Specific Example of Detection Method

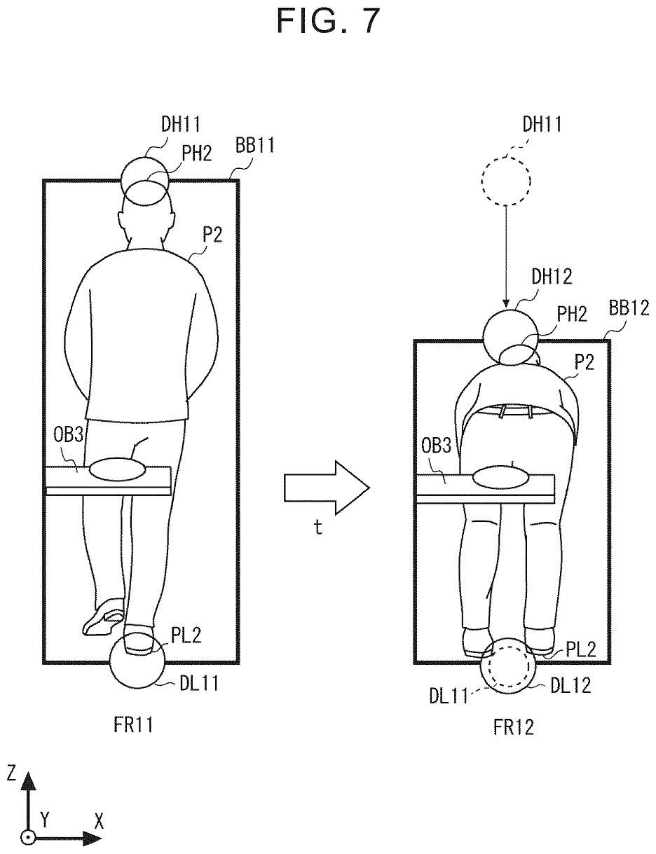

Next, a second specific example of the detection method performed by the detection system 10 will be described with reference to FIG. 7.

In the present specific example, as illustrated in FIG. 7, an obstacle OB3 and a detection target person P2 whose posture is varied are captured every moment, and the detection method performed by the detection system 10 is applied to a plurality of images captured in this manner. The obstacle OB3 is a shelf. Only part of the upper part of legs of the detection target person P2 is hidden by the obstacle OB3. FIG. 7 illustrates a preceding frame image FR11 and a present frame image FR12. The present frame image FR12 was captured at the time point when a period t has elapsed since the time point when the preceding frame image FR11 was captured.

In ST1, a bounding box BB11 as a region that indicates the detection target person P2 is generated in the preceding frame image FR11. The foot detection unit 1 detects the midpoint of the lower side of a rectangle indicated by the bounding box BB11 as a position DL11 of feet PL2 of the detection target person P2. The upper body detection unit 2 detects the midpoint of the upper side of the rectangle indicated by the bounding box BB11 as a position DH11 of a head PH2 of the detection target person P2. The detected position DL11 is substantially the same as the actual position of the feet PL2, and the detected position DH11 is substantially the same as the actual position of the head PH2. Hence, the position of the feet PL2 and the position of the head PH2 of the detection target person P2 can be detected with high precision.

Similarly, a bounding box BB12 as a region that indicates the detection target person P2 is generated in the present frame image FR12. The foot detection unit 1 detects the midpoint of the lower side of a rectangle indicated by the bounding box BB12 as a position DL12 of the feet PL2 of the detection target person P2. The upper body detection unit 2 detects the midpoint of the upper side of the rectangle indicated by the bounding box BB12 as a position DH12 of the head PH2 of the detection target person P2. The detected position DH12 is substantially the same as the actual position of the head PH2, and the detected position DL12 is substantially the same as the actual position of the feet PL2. Hence, the position of the feet PL2 and the position of the head PH2 of the detection target person P2 can be detected with high precision.

In ST2, the position DL1 and the position DL12 are compared to calculate the moving distance and the moving direction of the feet PL2. The distance between the position DL11 and the position DL12 is the moving distance of the feet PL2, and is substantially zero. Therefore, the moving distance of the feet PL2 is substantially zero, and the moving direction of the feet PL2 cannot be specified.

Similarly, the position DH11 and the position DH12 are compared to calculate the moving distance and the moving direction of the head PH2. The distance between the position DH11 and the position DH12 is the moving distance of the head PH2, and has a predetermined length. The moving distance of the head PH2 is more than a predetermined value. The moving direction of the head PH2 is an up-down direction that extends substantially in the positive Z-axis direction.

In ST3, it is determined whether only the moving distance of the feet PL2 is more than a predetermined value and only the feet PL2 are moved in the up-down direction. As described above, the moving distance of the feet PL2 is substantially zero, and thus is not more than the predetermined value. The moving direction of the feet PL2 cannot be specified, and the moving direction of the head PH2 is the up-down direction. Hence, only the feet PL2 are not moved in the up-down direction. Hence, it is determined that only the moving distance of the feet PL2 is not more than the predetermined value and only the feet PL2 are not moved in the up-down direction (ST3: NO).

In ST6, it is determined whether the moving distance of the feet PL2 and the moving distance of the head PH2 are more than the predetermined value and the feet PL2 and the head PH2 are moved in the up-down direction. As described above, the moving distance of the feet PL2 is substantially zero, and thus is not more than the predetermined value. In addition, the moving direction of the feet PL2 cannot be specified. It is determined that the moving distance of the feet PL2 and the moving distance of the head PH2 are more than the predetermined value and the feet PL2 and the head PH2 are not moved in the up-down direction (ST6: NO).

In ST8, it is determined whether only the moving distance of the head PH2 is more than the predetermined value. As described above, the moving distance of the feet PL2 is not more than the predetermined value, and the moving distance of the head PH2 is more than the predetermined value. Hence, it is determined that only the moving distance of the head PH2 is more than the predetermined value (ST8: YES).

In ST9, it is estimated that the posture of the detection target person P2 is varied, or that the head PH2 of the detection target person P2 is hidden behind an obstacle. In reality, as illustrated in FIG. 7, only part of the upper portion of the legs of the detection target person P2 is hidden behind the obstacle OB3, the head PH2 is not hidden behind an obstacle, and the posture of the detection target person P2 is varied. Hence, the estimation result described above is reasonable to a certain degree, and the estimation precision is high. It is not necessary to correct the detected position of the feet, since the position of the feet PL2 and the position of the head PH2 of the detection target person P2 are detected with high precision as discussed in relation to ST1.

### Third Specific Example of Detection Method

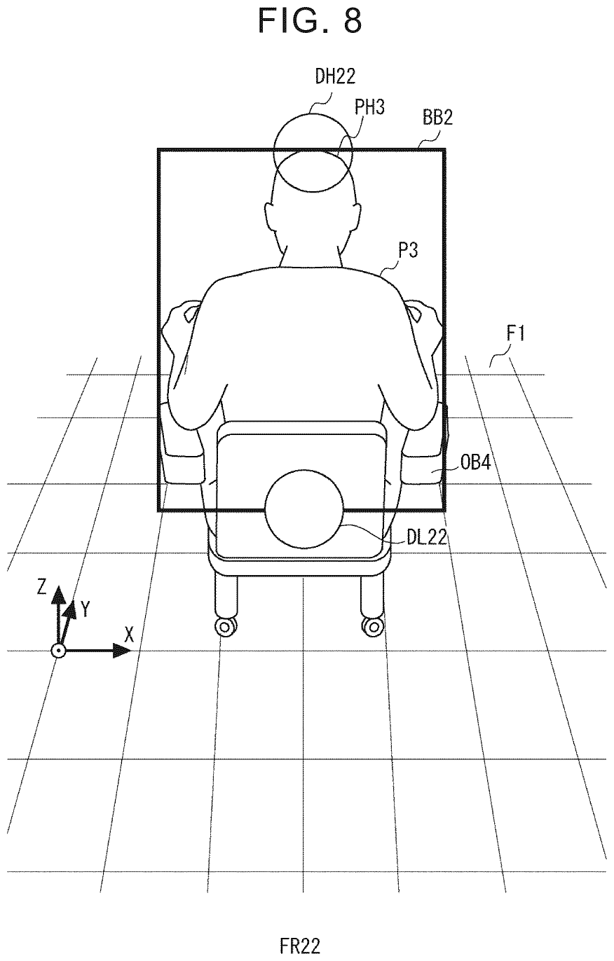

Next, a third specific example of the detection method performed by the detection system 10 will be described with reference to FIG. 8.

In the present specific example, as illustrated in FIG. 8, a detection target person P3 that repeatedly sits down on and stands up from an obstacle OB4 that is a chair is captured every moment, and the detection method performed by the detection system 10 is applied to a plurality of images captured in this manner. Legs of the detection target person P3 are hidden behind the obstacle OB4.

In the present specific example, ST1, ST2, ST3, ST6, ST8, and ST9 are performed in this order as in the second specific example of the detection method performed by the detection system 10 described above.

In ST1, a bounding box BB2 as a region that indicates the detection target person P3 is generated in the present frame image FR22. The foot detection unit 1 detects the midpoint of the lower side of a rectangle indicated by the bounding box BB2 as a position DL22 of the feet PL3 of the detection target person P3. The feet PL3 of the detection target person P3 are hidden behind the obstacle OB4, but are substantially at the same position as the position DL22. The upper body detection unit 2 detects the midpoint of the upper side of the rectangle indicated by the bounding box BB2 as a position DH22 of the head PH3 of the detection target person P3. The detected position DH22 is substantially the same as the actual position of the head PH3. The detected position DL22 is substantially the same as the actual position of the feet PL3. Hence, the position of the feet PL3 and the position of the head PH3 of the detection target person P3 can be detected with high precision.

In ST9, it is estimated that the posture of the detection target person P3 is varied, or that the head PH3 of the detection target person P3 is hidden behind an obstacle. In reality, as illustrated in FIG. 8, the legs of the detection target person P3 are hidden behind the obstacle OB4, and the head PH3 is not hidden behind an obstacle. Meanwhile, the posture of the detection target person P3 is varied, since the detection target person P3 repeatedly sits down and stands up. Hence, the estimation result described above is reasonable to a certain degree, and the estimation precision is high. It is not necessary to correct the detected position of the feet, since the position of the feet PL3 and the position of the head PH3 of the detection target person P3 are detected with high precision as discussed in relation to ST1.

### Other Embodiments Etc

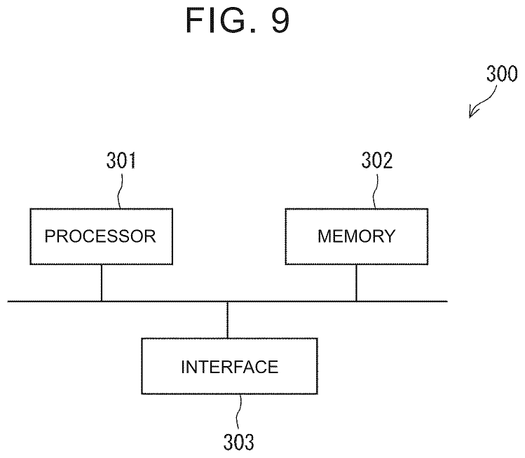

The detection system according to the above embodiments may include the following hardware components. FIG. 9 illustrates an example of the configuration of hardware components included in the detection system. As the procedures of the detection method performed by the detection system are described in relation to the various embodiments discussed above, the present disclosure may also take the form of a detection method.

A detection system 300 illustrated in FIG. 9 includes a processor 301 and a memory 302 in addition to an interface 303. The various components (see FIG. 1) of the detection system 10 described in relation to the embodiments discussed above are implemented by the processor 301 loading and executing a program stored in the memory 302. That is, this program is a control program causing the processor 301 to function as the detection system 10 or a part of the detection system 10.

The program discussed above includes a group of instructions (or software codes) for causing a computer to perform one or more of the functions described in relation to the embodiments when loaded into the computer. The program may be stored in a non-transitory computer-readable medium or a tangible storage medium. Examples of the computer-readable medium or the tangible storage medium include, but are not limited to, a random-access memory (RAM), a read-only memory (ROM), a flash memory, a solid-state drive (SSD), and other memory technologies, a compact disc read-only memory (CD-ROM), a digital versatile disc (DVD), a Blu-ray (registered trademark) disc, and other optical disc storages, and a magnetic cassette, a magnetic tape, a magnetic disk storage, and other magnetic storage devices. The program may be transmitted on a transitory computer-readable medium or a communication medium. Examples of the transitory computer-readable medium or the communication medium include, but are not limited to, propagating signals in electrical, optical, acoustic, or other forms.

The program discussed above may be a control program causing the detection system 10 to execute such a detection method.

The present disclosure is not limited to the embodiments described above, and may be modified as appropriate without departing from the spirit and scope of the disclosure. The present disclosure may be carried out by combining the above embodiments and examples thereof as appropriate.

While the position of the head of the detection target person is detected in the examples of the detection method according to the present embodiment, the position of at least part of the upper body, e.g. the trunk or the entire upper body, may be detected.

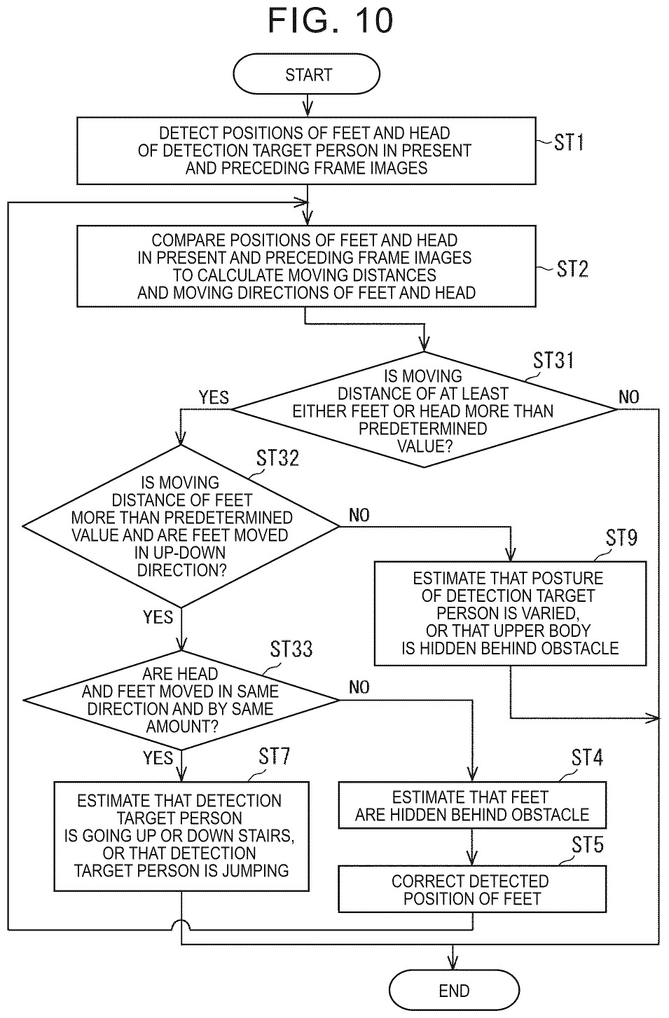

While ST1 to ST9 are performed in the examples of the detection method performed by the detection system 10 according to the embodiments, ST1, ST2, ST31, ST32, ST33, ST4, ST5, ST7, and ST9 may be performed as illustrated in FIG. 10. In ST31, it is determined whether at least one of the moving distance of the feet and the moving distance of the head is more than a predetermined value. In ST32, it is determined whether the moving distance of the feet is more than the predetermined value and the feet are moved in the up-down direction. In ST33, it is determined whether the head is moved in the same direction and by the same amount as the feet. That is, it is determined whether the head is moved in the up-down direction and the moving distance of the head and the moving distance of the feet are substantially equal to each other.

What is claimed is:

1. A detection system comprising:
a foot detection unit configured to detect a position of a foot of a detection target person;
an upper body detection unit configured to detect a position of at least part of an upper body of the detection target person; and
an estimation unit configured to estimate a state of the detection target person based on a moving distance of the foot calculated by using the detected position of the foot and based on a moving distance of the at least part of the upper body calculated by using the detected position of the at least part of the upper body.

2. The detection system according to claim 1, wherein the estimation unit is configured to estimate that at least part of a lower body of the detection target person is hidden behind an obstacle in a case where only the moving distance of the foot is more than a predetermined value and only the foot is moved in an up-down direction.

3. The detection system according to claim 1, wherein the estimation unit is configured to estimate that the detection target person is going up or down stairs, or that the detection target person is jumping, in a case where the moving distance of the foot and the moving distance of the at least part of the upper body are more than a predetermined value and the foot and the at least part of the upper body are moved in an up-down direction.

4. The detection system according to claim 1, wherein the estimation unit is configured to estimate that a posture of the detection target person is varied, or that the at least part of the upper body of the detection target person is hidden behind an obstacle, in a case where only the moving distance of the at least part of the upper body is more than a predetermined value.

5. The detection system according to claim 2, further comprising a correction unit, wherein the correction unit is configured to correct the detected position of the foot to a position of the foot based on a skeleton of the detection target person, in a case where the estimation unit estimates that the at least part of the lower body of the detection target person is hidden behind the obstacle.

6. A detection method performed by a detection system, comprising:
detecting a position of a foot of a detection target person;
detecting a position of at least part of an upper body of the detection target person; and
estimating a state of the detection target person based on a moving distance of the foot calculated by using the detected position of the foot and based on a moving distance of the at least part of the upper body calculated by using the detected position of the at least part of the upper body.

7. A non-transitory storage medium storing instructions that are executable by one or more processors operating in a detection system and that cause the one or more processors to perform functions comprising:
detecting a position of a foot of a detection target person;
detecting a position of at least part of an upper body of the detection target person; and
estimating a state of the detection target person based on a moving distance of the foot calculated by using the detected position of the foot and based on a moving distance of the at least part of the upper body calculated by using the detected position of the at least part of the upper body.
